(19) United States
(12) Patent Application Publication
(10) Pub. No.: US 2003/0233229 A1
(43) Pub. Date: Dec. 18, 2003

(54) Digital audio signal processing method with improved processing efficiency

(76) Inventors: Wen-Long Tseng, Taipei Hsien (TW); Wen-Lung Hsu, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,042

(22) Filed: Jun. 4, 2002

(30) Foreign Application Priority Data
Apr. 11, 2002 (TW) 091107381

(51) Int. Cl. G10L 21/00

(52) U.S. Cl. 704/212

(57) ABSTRACT

A digital audio signal processing method includes establishing a first frequency response corresponding to an audio signal, generating a second frequency response based on the first frequency response, and using the second frequency response to process the audio signal. The first frequency response has a plurality of first sampling points and a plurality of first amplitudes corresponding to the first sampling points respectively. The second frequency response is generated from selecting a portion of the first sampling points as second sampling points and corresponding first amplitudes as second amplitudes, in which the number of the second sampling points is less than the first sampling points. The second frequency response is used to process the audio signal through a convolution algorithm.

### BACKGROUND OF INVENTION

1. Field of the Invention

The present invention relates to a digital audio signal processing method, and more particularly, to a digital audio signal processing method with improved processing efficiency.

2. Description of the Prior Art

Recently, developments in semiconductor technology and computer technology have made daily life more comfortable. Specifically, digital signal processing technology is advancing by leaps and bounds. In addition, many electric components are fabricated on an integrated circuit (IC) to make one integrated circuit have many advantages such as small size, low cost, low power consumption, and a multi-function processing ability. Because digital signals have a better noise resistance than analog signals, the digital signal can be stored for a long time or be transmitted over a long distance with a negligible distortion. Digital signal processing technology, therefore, has been greatly developed for that reason. The digital signal is named because related parameters have discrete values such as time information and magnitude with regard to the signal. Because the parameters of the signal are based on discrete values, digital signal processing is mainly applied on a discrete time system, that is, a system handling discrete time signals. When a signal is digitized, digital signal processing is used for further handling the digital signal. For example, digital signal processing filters the digital signal for rectifying a corresponding frequency response in frequency domain, performs a spectrum analysis for the digital signal, and so forth. Concerning digital signal processing, a digital filter, which might be a finite impulse response (FIR) filter or an infinite impulse response (IIR) filter, is widely used. There have been many digital signal-processing algorithms disclosed in the past. A discrete Fourier transform (DFM), for example, is popularly used for transforming the discrete signal from time domain into frequency domain to better study the signal characteristic. In other words, digital signal processing is basically based on the discrete Fourier transform algorithm, and a digital signal processor (DSP), therefore, is also developed under this situation for helping users to deal with complex digital data.

The prices of personal computers are lower than before, and users now can afford to pay the lowered prices. Therefore, sales of personal computers have increased dramatically, making the personal computer become a standard and necessary appliance at home or in an office. In addition, because popularity of multimedia technology has grown, the personal computer is no longer just a word processor. With a powerful processing ability of the personal computer, images and music processed by the personal computer can entertain users sitting in front of the computer. For example, a sound card installed in the personal computer is capable of converting analog audio signals into corresponding digital audio signals, and is capable of converting digital audio signals into corresponding analog audio signals as well. Furthermore, lately the personal computer has come to function as a personal audio-visual system. The computer industry has produced many kinds of interface cards and peripherals, and the user consequently can add new functions to the personal computer through appropriate products connected to the personal computer. In other words, the user can use the personal computer for watching TV programs, listening to broadcasts, and seeing a movie. That is, many audio-visual functions of a home theater are gradually being integrated into the personal computer.

With the development of semiconductor technology, processing speed of computer components such as processor and video graphics array (VGA) cards is improving according to an operating clock having a higher frequency than before. Therefore, the personal computer is capable of dealing with a great amount of video and audio data. For example, the personal computer uses an optical disk drive to retrieve data stored in a recordable disk, uses a monitor to display images, and uses a speaker to play music. In order to give the music better sound effects, the personal computer has to provide an additional signal processing operation to generate a desired sound effect for converting digital audio signals into analog signals to drive the speaker. Generally speaking, a media player used for playing video and audio data contains an equalizer. The equalizer divides an audio spectrum into a plurality of frequency bands, and boosts or decays different frequency bands to change the original audio spectrum. In addition, some equalizers may have preset many sound effects such as a jazz music mode, a rock-and-roll music mode, and a classical music modeso that the user can quickly choose one of the preset sound effects to modify the original audio spectrum. Moreover, the equalizer is capable of compensating a distortion induced during a processing procedure. For example, when the user uses the sound card in the personal computer to record analog audio signals, the recorded signals having a high frequency may be decayed owing to recording interference of a recording device (a microphone). Therefore, when the audio signals are outputted from the sound card to the speaker after being appropriately converted from a digital format into an analog format, outputted signals in a high frequency section are weaker than the original signals, that is, a distortion is generated. Then, the equalizer is used for boosting the signals in a high frequency section for compensating the distortion mentioned before. However, the environment will also affect the sounds heard by the user. That is, different materials have different degrees on absorbing and scattering the incident audio signals. The user, therefore, has to use the equalizer to adjust the audio signals for improving the final sound reproduction. In addition, the speaker itself has a unique frequency response when outputting the audio signals. The speaker will affect the actual outputted sound owing to its frequency response characteristic. If the speaker is not good at playing audio signals in the intermediate frequency section, the equalizer is used for boosting signals in the intermediate frequency section to compensate the defect of the speaker. As mentioned above, the user can use the equalizer to improve the actual output audio spectrum for compensating a distortion induced during the signal processing procedure so that the sound reproduction can meet the user's requirement.

Please refer to FIG. 1 to FIG. 3. FIG. 1 is a diagram of a prior art digital equalizer 10. FIG. 2 is an impulse response 14 of the digital equalizer 10 shown in FIG. 1. FIG. 3 is a frequency response 12 of the impulse response 14 shown in FIG. 2. As mentioned above, the digital equalizer 10 functions like a filter for handling a frequency response of an input signal. First, an analog signal is converted into a corresponding digital input signal x[n] through a pulse code modulation (PCM). The digital equalizer 10 performs a convolution operation on the input signal x[n] to produce a corresponding output signal y[n]. The digital equalizer 10 has an impulse response 14, that is, h[n]. The impulse response 14 has a plurality of sampling points 16, and a total number of the sampling points 16 are termed as an impulse response length. When the impulse response length is greater, the number of sampling points 16 is greater as well. Therefore, the impulse response 14 will approach an ideal impulse response curve with more sampling points 16. The frequency response 12 corresponding to the impulse response 14 stands for characteristic of the digital equalizer 10. In the preferred embodiment, the frequency response 12 shows small amplitudes in a high frequency section, that is, the digital equalizer 10 is capable of decaying signals in a high frequency section. The relation among the input signal x[n], the output signal y[n], and the impulse response 14 h[n] is shown as follows.

y[n]=x[n]\mathring{x}h[n]

$$= {\sum }_{\text{?} = \text{?}}^{\text{?}} x [ i ] h [ n - 2 ] ( N is the impulse response length )$$

$$\text{?} \text{indicates text missing or illegible when filed}$$

Therefore, N multiplication operations and N−1 addition operations are executed to generate the final output signal y[n]. If the impulse response length becomes greater, that is, more sampling points 16 are used for approaching the ideal impulse response characteristic; the digital equalizer 10 can output the output signal y[n] with a much negligible distortion. However, a greater impulse response length will increase the total execution number (additions and multiplications) so that the processing time spent on the signal processing is increased. Not only is computer loading increased, but also utilization of a central processing unit (CPU) is increased. Therefore, other queued programs are affected by the time-consuming digital audio signal processing operation.

### SUMMARY OF INVENTION

It is therefore a primary objective of the claimed invention to provide a digital audio signal processing method with improved processing efficiency to solve the above-mentioned problem.

Briefly, the claimed invention provides a digital audio signal processing method for increasing an associated processing speed. The digital audio signal processing method includes presetting a first impulse response with regard to a frequency response of a digital audio signal in which the first impulse response has a plurality of first sampling points in time domain, a total number of the first sampling points equals a first predetermined value, and each first sampling point corresponds to a first amplitude; establishing a second impulse response by selecting a plurality of first sampling points and related first amplitudes from the first impulse response to function as second sampling points and related second amplitudes of the second impulse response in which a total number of the second sampling points being less than the first predetermined value; and processing the audio signal in time domain by the second impulse response according to a predetermined algorithm.

It is an advantage of the claimed invention that the claimed digital signal processing method uses a simplified impulse response extracted from an original predetermined impulse response, that is, sampling points with greater amplitudes are extracted from the predetermined impulse response to perform a convolution operation on an input signal. The claimed digital signal processing method not only reserves characteristic of the original impulse response, but also reduces computational complexity of the numerical operations.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a prior art digital equalizer.

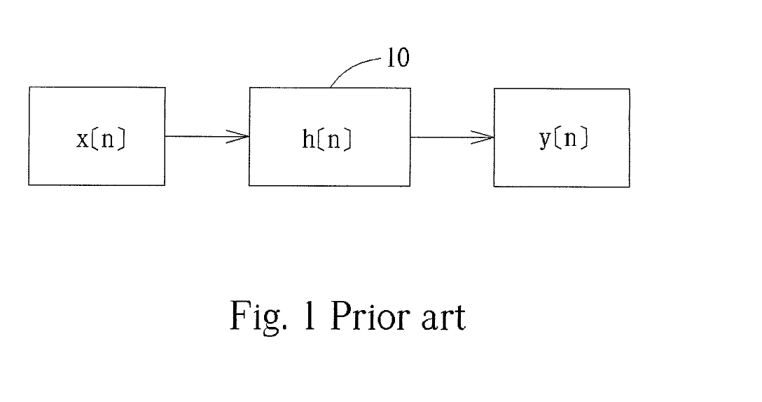

FIG. 2 is an impulse response of the digital equalizer shown in FIG. 1.

FIG. 3 is a frequency response of the impulse response shown in FIG. 2.

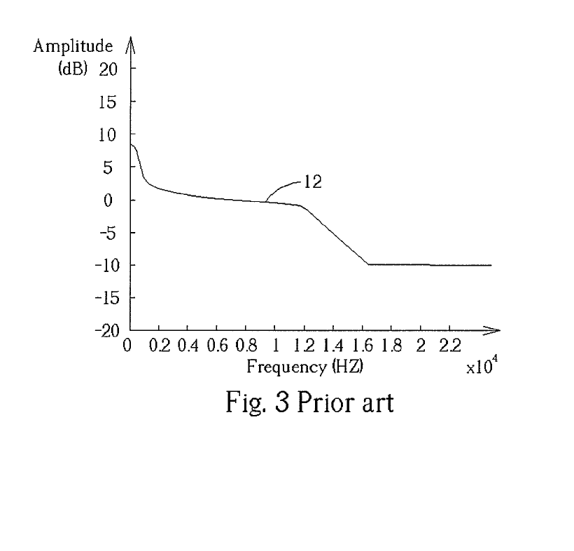

FIG. 4 is a diagram of an impulse response with regard to a digital equalizer according to the present invention.

FIG. 5 is a frequency response of the impulse response shown in FIG. 4.

### DETAILED DESCRIPTION

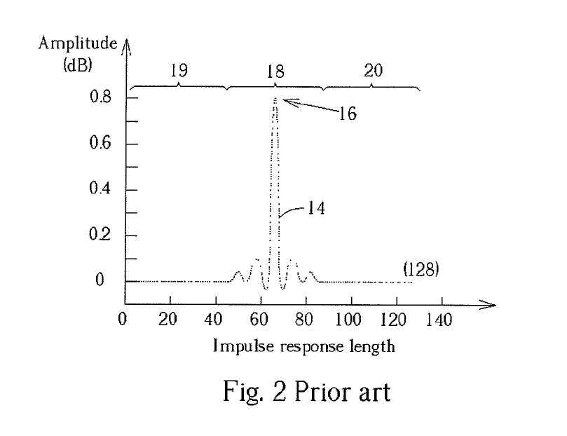

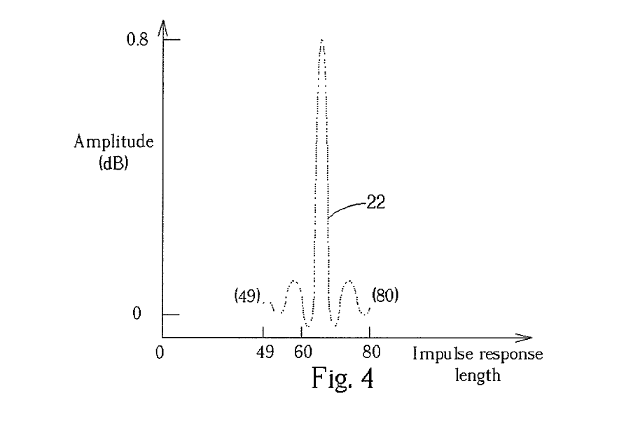

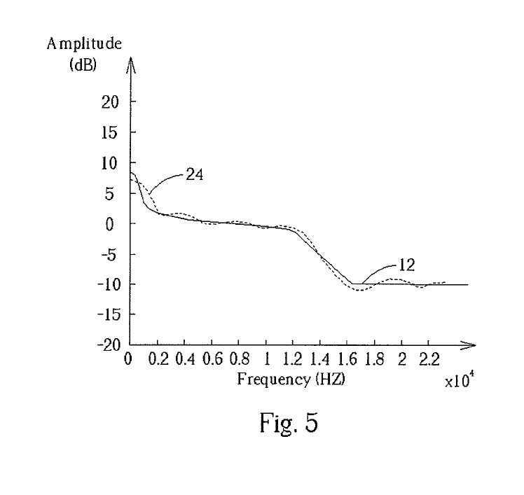

In order to better disclose the digital audio processing method according to the present invention, a digital equalizer applying the claimed digital audio processing method is adopted for clarity. Please refer to FIG. 2, FIG. 4, and FIG. 5. FIG. 4 is a diagram of an impulse response 22 with regard to a digital equalizer according to the present invention. FIG. 5 is a frequency response 24 of the impulse response 22 shown in FIG. 4. The impulse response 22 is generated by extracting sampling points 16 from a section 18 of the impulse response 14 (shown in FIG. 2). The sampling points 16 in the section 18 correspond to greater amplitudes. On the contrary, amplitudes of the sampling points in the sections 19, 20 approach zero approximately. For the digital equalizer 10, the sampling points 16 in the section 18 have great weight on the impulse response 14. That is, the section 18 is regarded as a main frame of the impulse response 14, and average amplitude of the sampling points 16 in the section 18 is greater than overall average amplitude of all sampling points 16 within the impulse response 14. In addition, the impulse response 14 is symmetrical in the preferred embodiment with the section 18 located in the curve center of the impulse response 14, that is, the characteristic curve related to the impulse response 14 can be shifted to make the impulse response 14 symmetrical. After being shifted in time domain through a proper time delay mechanism, the impulse response 14 can adjust the section 18 that has sampling points 16 with greater amplitudes to be located in the center of the characteristic curve, and other sampling points 16 with smaller amplitudes are distributed in sections 19, 20. When an input signal is multiplied by the impulse response 14 according to a well-known convolution algorithm, the section 18, for the most part, is responsible for generating the final output signal because the sampling points 16 in the section 18 have greater amplitudes. On the contrary, the sections 19, 20 have slight effects on the final output signal because the sampling points 16 in the sections 19, 20 have negligible amplitudes. In other words, an average power of sampling points 16 in the section 18 is greater than 99% of an average power of all sampling points 16 within the impulse response 14. Therefore, when the input signal is multiplied by the impulse response 14 according to the convolution algorithm, the sampling points 16 in the sections 19, 20 are abandoned according to the present invention. In the preferred embodiment, only sampling points 16 in the section 18 are used for performing the convolution algorithm on the input signal. The operation of the claimed digital audio signal processing method is described as follows.

The input signal in time domain is represented by x[n], and is represented by X(e^{jw}) in frequency domain. The relation between the x[n] and X(e^{jw}) is described with the help of a well-known Fourier transform algorithm.

$$\begin{matrix}X ( {ⅇ}^{jw} ) = {\sum }_{\text{?} = \text{?}}^{\text{?}} x [ n ] {ⅇ}^{- \text{?}} \\ x [ n ] = \frac{1}{2 π} {\int }_{\text{?}}^{} 3 \text{?} ( {ⅇ}^{\text{?}} ) {\text{?}}^{} ⅆ w .\end{matrix}$$

$$\text{?} \text{indicates text missing or illegible when filed}$$

In order to extract sampling points 16 in the section 18 from the impulse response 14, the digital equalizer, in the preferred embodiment, uses a window function multiplying the impulse response 14 in time domain to achieve the objective. Suppose the impulse response 14 has 128 sampling points 16, and 32 sampling points 16 are located in the section 18. That is, the forty-ninth sampling point 16 to the eightieth sampling point 16 are in the section 18. Therefore, a rectangular window function is used under this situation.

$$\begin{matrix}w [ n ] = \{ \begin{matrix}\text{1,49} \leq n \leq 80 \\ 0 , otherwise\end{matrix} \\ W ( {ⅇ}^{\text{?}} ) = {\sum }_{\text{?}}^{} \text{?}\end{matrix}$$

$$\text{?} \text{indicates text missing or illegible when filed}$$

A relation among the impulse response 22, the impulse response 14, and the rectangular window function is described as follows.

$$\begin{matrix}{h}^{′} [ n ] = h [ {n}^{″} ] \text{?} [ n ] = \frac{1}{2 π} {\int }_{\text{?}} H ( {ⅇ}^{\text{?}} ) {ⅇ}^{( \text{?} )} ⅆ w , \\ in which 49 \leq n \leq 80\end{matrix}$$

$$\text{?} \text{indicates text missing or illegible when filed}$$

The forty-ninth sampling point 16 to the eightieth sampling point 16 are extracted from the impulse response 14 according to the rectangular window function. Because the impulse response 22 is a multiplication of the impulse response 14 and the rectangular window function, the frequency response 24 in frequency domain corresponding to the impulse response 22 in time domain is shown below.

H′[e^{jw}]=H[e^{jw}]\mathring{×}W[e^{jw}]

It is noteworthy that the characteristic of the w[n] is equivalent to a sinc function. In other words, the frequency response 24 in frequency domain will oscillate owing to the sinc function (shown in FIG. 5). However, the user is not sensitive to the slight oscillation generated by the sinc function after an appropriate experiment. Then, the input signal x[n] is multiplied by the impulse response (h′[n]) according to the convolution algorithm.

y[n]=x[n]\mathring{x}h′[n]

As mentioned before, the impulse response 22 only has 32 sampling points, the digital equalizer 10, therefore, only executes 32 multiplication operations and 31 addition operations.

In the preferred embodiment, the analog signal is converted into a corresponding digital signal according to a pulse code modulation, and a sampling rate related to the pulse code modulation determines an interval between each sampling point in time domain. In addition, a rectangular window function is used in the preferred embodiment to extract one section of the impulse response 22. However, the digital equalizer 10 is capable of adopting other window functions such as a triangular window function, a Hanning window function, and a Blackman window function to extract the section 18 located in the impulse response 14. It is noteworthy that the average power of the sampling points 16 within the section 18 has to be greater than a predetermined percentage (99% for example) of the average power related to the all sampling points 16 of the impulse response 14. The extracted sampling points 16 are then multiplied by an input signal through a convolution algorithm to alter a corresponding frequency response of the input signal. In conclusion, the overall loading generated from those numerical operations is greatly reduced to improve processing performance of the digital equalizer 10.

In contrast to the prior art, the digital audio processing method according to the present invention uses a simplified impulse response extracted from an original predetermined impulse response, that is, sampling points with greater amplitudes are extracted from the predetermined impulse response to perform a convolution operation on an input signal. Although the extracted sampling points has an average power greater than 99% of an average power related to the original sampling points, a final frequency response of the input signal compared with an ideal frequency response is slightly distorted. After verification of advanced experiments, the user is not sensitive to those negligible variations. To sum up, the claimed digital audio signal processing method not only reserves characteristics of the original impulse response, but also reduces computational complexity of the numerical operations. In addition, processing efficiency related to digital signal processing is increased to greatly reduce loading of the corresponding computer system, and the processing performance of the computer system is improved.

Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A digital audio signal processing method for increasing an associated processing speed, comprising:
presetting a first impulse response with regard to a frequency response of a digital audio signal, said first impulse response having a plurality of first sampling points in time domain, a total number of said first sampling points equaling a first predetermined value, each first sampling point corresponding to a first amplitude;
establishing a second impulse response by selecting a plurality of first sampling points and related first amplitudes from said first impulse response to function as second sampling points and related second amplitudes of said second impulse response, a total number of said second sampling points being less than said first predetermined value; and
processing said audio signal in time domain by said second impulse response according to a predetermined algorithm.

2. The digital audio signal processing method of claim 1 being applied on a digital equalizer.

3. The digital audio signal processing method of claim 1 wherein said first sampling points are spaced by a fixed interval in time domain.

4. The digital audio signal processing method of claim 1 wherein an average power of said second amplitudes associated with said second impulse response is greater than a predetermined percentage of an average power of said first amplitudes associated with said first impulse response.

5. The digital audio signal processing method of claim 4 wherein said predetermined percentage is 99%.

6. The digital audio signal processing method of claim 1 wherein said digital audio signal is generated by performing a pulse code modulation (PCM) on an analog audio signal.

7. The digital audio signal processing method of claim 6 wherein a sampling rate of said pulse code modulation determines an interval between each sampling point in time domain.

8. The digital audio signal processing method of claim 1 wherein said predetermined algorithm is a convolution algorithm.

9. The digital audio signal processing method of claim 2 wherein said digital equalizer is a software program.

10. The digital audio signal processing method of claim 1 wherein said second impulse response is generated from said first impulse response multiplied by a window function in time domain.
